(19) United States
(12) Patent Application Publication
(10) Pub. No.: US 2026/0148696 A1
(43) Pub. Date: May 28, 2026

(54) Pixel Circuit and Display Device Including the Same

(71) Applicant: LG Display Co., Ltd., Seoul (KR)

(72) Inventors: Min Seon Park, Paju-si (KR); Sang Hee Yu, Paju-si (KR); Ye Rin Ahn, Paju-si (KR)

(21) Appl. No.: 19/346,331

(22) Filed: Sep. 30, 2025

(30) Foreign Application Priority Data
Nov. 25, 2024 (KR) 10-2024-0169209

(51) Int. Cl. G09G 3/3233

(52) U.S. Cl. CPC G09G 3/3233; G09G 2300/0819; G09G 2310/08; G09G 2320/0209; G09G 2320/0233

(57) ABSTRACT

A pixel circuit according to an embodiment and display device including the same is disclosed. The display device includes a pixel array in which a plurality of data lines, a plurality of gate lines, and a plurality of pixels are arranged, a data driver configured to output data voltages to the plurality of data lines, a gate driver arranged among the plurality of pixels and configured to output gate signals to the plurality of gate lines, and a level shifter configured to generate first and second clock signals for the gate driver, wherein the gate driver comprises a first gate driver arranged on odd-numbered column lines and configured to receive the first clock signal, and a second gate driver arranged on even-numbered column lines and configured to receive the second clock signal.

### CROSS-REFERENCE TO RELATED APPLICATIONS

This application claims priority to and the benefit of Republic of Korea Patent Application No. 10-2024-0169209, filed Nov. 25, 2024, the disclosure of which is incorporated herein by reference in its entirety.

### FIELD

The present disclosure relates to an apparatus and particularly to, for example, without limitation, a pixel circuit and a display device including the same.

### DISCUSSION OF RELATED ART

Display devices includes a liquid crystal display (LCD) device, an electroluminescence display device, a field emission display (FED) device, a plasma display panel (PDP), and the like.

Electroluminescent display devices are divided into inorganic light emitting display devices and organic light emitting display devices according to a material of a light emitting layer. An active-matrix type organic light emitting display device reproduces an input image using a self-emissive element which emits light by itself, for example, an organic light emitting diode (hereinafter referred to as an “OLED”). An organic light emitting display device has advantages in that a response speed is fast and luminous efficiency, luminance, and a viewing angle are large.

Some of display devices, for example, a liquid crystal display device or an organic light emitting display device includes a display panel including a plurality of sub-pixels, a driver outputting a driving signal for driving the display panel, a power supply generating power to be supplied to the display panel or the driver, and the like. The driver includes a gate driver that supplies a scan signal or a gate signal to the display panel, and a data driver that supplies a data signal to the display panel.

The description provided in the discussion of the related art section should not be assumed to be prior art merely because it is mentioned in or associated with that section. The discussion of the related art section may include information that describes one or more aspects of the subject technology, and the description in this section does not limit the disclosure.

### SUMMARY

Each of a plurality of pixels includes a driving element that controls the driving current flowing through the light-emitting element according to the voltage applied between the gate electrode and the source electrode (Vgs). When the source electrode of the driving element and the anode electrode of the light-emitting element are initialized or reset, a current flows through the power line to which the initialization voltage is applied, causing a ripple to occur in the initialization voltage.

The voltage at the gate electrode and source electrode of the driving element may fluctuate due to this ripple in the initialization voltage, which may cause sensing errors, crosstalk due to emission errors, low-grayscale stains, and luminance uniformity reduction.

The present disclosure is directed to solving all the above-described necessity and problems.

The present disclosure provides a pixel circuit capable of compensating for power ripple, and a display device including the same.

It should be noted that objects of the present disclosure are not limited to the above-described objects, and other objects of the present disclosure will be apparent to those skilled in the art from the following descriptions.

A pixel circuit according to embodiments of the present disclosure may include a light-emitting element; a driving element that drives the light-emitting element and includes a first electrode connected to a first node, a gate electrode connected to a second node, and a second electrode connected to a third node; a first switch element that supplies a data voltage to the second node in response to a first scan signal; a second switch element that supplies a reference voltage to the second node in response to a second scan signal; a third switch element that supplies a pixel driving voltage to the first node in response to a first emission signal; a fourth switch element that connects a fourth node to the third node in response to a second emission signal; a compensation circuit that supplies an initialization voltage to the fourth node in response to a third scan signal and supplies a compensation voltage for compensating for a ripple in the initialization voltage to the fourth node; and a first capacitor connected between the second node and the third node.

A pixel circuit according to embodiments of the present disclosure may include a light-emitting element; a driving element that drives the light-emitting element and includes a first electrode connected to a line to which a pixel driving voltage is applied, a gate electrode connected to a first node, and a second electrode connected to a second node; a first switch element that supplies a data voltage to the first node in response to a first scan signal; a second switch element that supplies a reference voltage to the first node in response to a second scan signal; a third switch element that connects an anode electrode of the light-emitting element to the second node in response to an emission signal; a compensation circuit that supplies an initialization voltage to the fourth node in response to a third scan signal and supplies a compensation voltage for compensating for a ripple in the initialization voltage to the second node; and a first capacitor connected between the first node and the second node.

A display device according to embodiments of the present disclosure may include a display panel on which a plurality of data lines, a plurality of gate lines intersecting the data lines, and a plurality of pixel circuits are arranged, wherein each of the pixel circuits comprises a light-emitting element; a driving element that drives the light-emitting element and includes a first electrode connected to a first node, a gate electrode connected to a second node, and a second electrode connected to a third node; a first switch element that supplies a data voltage to the second node in response to a first scan signal; a second switch element that supplies a reference voltage to the second node in response to a second scan signal; a third switch element that supplies a pixel driving voltage to the first node in response to a first emission signal; a fourth switch element that connects a fourth node to the third node in response to a second emission signal; a compensation circuit that supplies an initialization voltage to the fourth node in response to a third scan signal and supplies a compensation voltage for compensating for a ripple in the initialization voltage to the fourth node; and a first capacitor connected between the second node and the third node.

A display device according to embodiments of the present disclosure may include a display panel on which a plurality of data lines, a plurality of gate lines intersecting the data lines, and a plurality of pixel circuits are arranged, wherein each of the pixel circuits comprises: a light-emitting element; a driving element that drives the light-emitting element and includes a first electrode connected to a line to which a pixel driving voltage is applied, a gate electrode connected to a first node, and a second electrode connected to a second node; a first switch element that supplies a data voltage to the first node in response to a first scan signal; a second switch element that supplies a reference voltage to the first node in response to a second scan signal; a third switch element that connects an anode electrode of the light-emitting element to the second node in response to an emission signal; a compensation circuit that supplies an initialization voltage to the second node in response to a third scan signal and supplies a compensation voltage for compensating for a ripple in the initialization voltage to the second node; and a first capacitor connected between the first node and the second node.

In the present disclosure, a compensation circuit including two switch elements and one capacitor for initializing the source electrode of the driving element is provided, so that an initialization voltage and a compensation voltage for compensating for a ripple in the initialization voltage are supplied together from the compensation circuit, thereby compensating for the ripple in the initialization voltage.

In the present disclosure, since it is possible to compensate for a ripple in the initialization voltage, the voltages of the gate electrode and the source electrode of the driving element do not fluctuate, so that improvement may be made in crosstalk, low-grayscale stains, and luminance deviation caused by sensing errors and emission errors.

The present disclosure enables low-power driving by compensating for a ripple in the initialization voltage.

The effects of the present specification are not limited to the above-mentioned effects, and other effects that are not mentioned will be apparently understood by those skilled in the art from the following description and the appended claims.

It is to be understood that both the foregoing general description and the following detailed description are exemplary and explanatory and are intended to provide further explanation of the inventive concepts as claimed.

### BRIEF DESCRIPTION OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to an embodiment of the present disclosure;

FIG. 2 is a diagram illustrating a pixel circuit according to a first embodiment of the present disclosure;

FIG. 3 is a diagram illustrating the driving timing of the pixel circuit shown in FIG. 2;

FIGS. 4A to 4F are diagrams for explaining the operating principle of the pixel circuit according to FIG. 2;

FIG. 5 is a diagram illustrating a pixel circuit according to a second embodiment of the present disclosure;

FIG. 6 is a diagram illustrating the driving timing of the pixel circuit shown in FIG. 5;

FIG. 7 is a diagram illustrating a pixel circuit according to a third embodiment of the present disclosure;

FIG. 8 is a diagram illustrating the driving timing of the pixel circuit shown in FIG. 7;

FIG. 9 is a diagram illustrating a pixel circuit according to a fourth embodiment of the present disclosure;

FIG. 10 is a diagram illustrating the driving timing of the pixel circuit shown in FIG. 9;

FIGS. 11A to 11D are diagrams for explaining the operating principle of the pixel circuit according to FIG. 9; and

FIGS. 12A and 12B are diagrams illustrating a ripple reduction effect obtained by the pixel circuit.

### DETAILED DESCRIPTION

Advantages and features of the present specification and methods of achieving them will become apparent with reference to preferable embodiments, which are described in detail, in conjunction with the accompanying drawings. However, the present specification is not limited to the embodiments to be described below and may be implemented in different forms, the embodiments are only provided to completely disclose the present disclosure and completely convey the scope of the present disclosure to those skilled in the art, and the present specification is defined by the disclosed claims.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the specification. Further, in describing the present disclosure, when it is determined that a detailed description of related known technology may unnecessarily obscure the gist of the present disclosure, the detailed description thereof will be omitted.

When ‘including,’ ‘having,’ ‘consisting,’ and the like mentioned in the present specification are used, other parts may be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to, and the like, one or more other parts may be located between the two parts unless ‘immediately’ or ‘directly’ is used.

Although first, second, and the like are used to describe various components, these components are not limited by these terms. These terms are only used to distinguish one component from another. Accordingly, a first component, which is mentioned, below may also be a second component within the technical idea of the present disclosure.

The same reference numerals may refer to substantially the same elements throughout the present disclosure.

The following embodiments can be partially or entirely bonded to or combined with each other and can be linked and operated in technically various ways. The embodiments can be carried out independently of or in association with each other.

Reference will be made in detail to embodiments of the present disclosure, examples of which may be illustrated in the accompanying drawings. In the following description, when a detailed description of well-known functions or configurations related to this document is determined to unnecessarily cloud a gist of the inventive concept, the detailed description thereof will be omitted. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations may be selected only for convenience of writing the specification and may be thus different from those used in actual products.

Any implementation described herein as an “example” is not necessarily to be construed as preferred or advantageous over other implementations.

In describing a temporal relationship, when the temporal order is described as, for example, “after,” “subsequent,” “next,” and “before,” a case that is not continuous may be included unless a more limiting term, such as “just,” “immediate(ly),” or “direct(ly)” is used.

Also, when an element or layer is “connected,” “coupled,” or “adhered” to another element or layer denotes that the element or layer can not only be directly connected or adhered to the other element or layer, but also be indirectly connected or adhered to the other element or layer with one or more intervening elements or layers “disposed,” or “interposed” between the elements or layers, unless otherwise specified. It should be understood to mean that elements may be so disposed to directly contact each other, or may be so disposed without directly contacting each other.

The expression of a first element, a second elements “and/or” a third element should be understood as one of the first, second and third elements or as any or all combinations of the first, second and third elements. By way of example, A, B and/or C can refer to only A; only B; only C; any or some combination of A, B, and C; or all of A, B, and C.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

Rather, these embodiments may be provided so that this disclosure may be sufficiently thorough and complete to assist those skilled in the art to fully understand the scope of the present disclosure.

Hereinafter, various embodiments of the present disclosure will be described in detail with reference to the accompanying drawings.

In a display device of the present disclosure, the pixel circuit and the gate driving circuit may include a plurality of transistors. Transistors may be implemented as oxide thin film transistors (oxide TFTs) including an oxide semiconductor, low temperature polysilicon (LTPS) TFTs including low temperature polysilicon, or the like.

A gate signal swings between a gate-on voltage and a gate-off voltage. The gate-on voltage is set to a voltage higher than a threshold voltage of a transistor, and the gate-off voltage is set to a voltage lower than the threshold voltage of the transistor.

The transistor is turned on in response to the gate-on voltage and is turned off in response to the gate-off voltage. In the case of the n-channel transistor, a gate-on voltage may be a gate high voltage, and a gate-off voltage may be a gate low voltage. In the case of the p-channel transistor, a gate-on voltage may be a gate low voltage, and a gate-off voltage may be a gate high voltage.

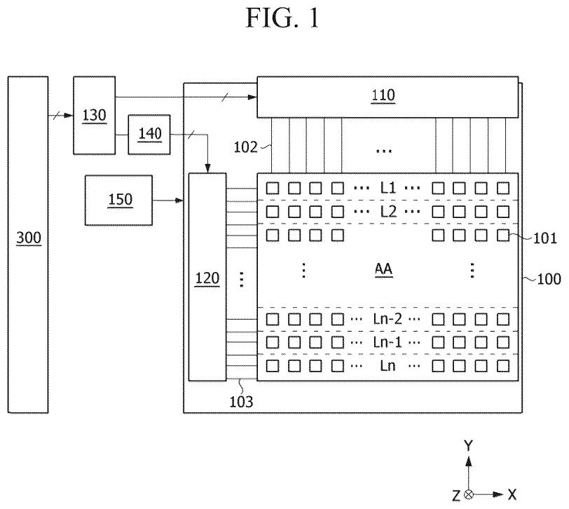

FIG. 1 is a block diagram illustrating a display device according to an embodiment of the present disclosure.

Referring to FIG. 1, the display device according to an embodiment of the present disclosure includes a display panel 100, and a display panel driving circuit for writing pixel data to pixels of the display panel 100. Additionally, the display device includes a power supply 150.

The display panel 100 may be, but not limited to, a panel having a rectangular structure with a length in the X-axis direction, a width in the Y-axis direction, and a thickness in the Z-axis direction. For example, the display panel 100 may be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels arranged in a matrix form. The display panel 100 may further include power lines commonly connected to the pixels. The power lines may be commonly connected to pixel circuits to supply a voltage required for driving pixels 101 to the pixels 101.

Each of the pixels 101 may be divided into a red sub-pixel, a green sub-pixel, and a blue sub-pixel for color implementation. Each pixel may further include a white sub-pixel. Each sub-pixel includes a pixel circuit for driving a light emitting element. The light emitting element may include an OLED or an inorganic light emitting diode (LED). Each pixel circuit is connected to the data lines, the gate lines, and the power lines. In the following description, a pixel may be interpreted as a sub-pixel.

The pixels may be disposed as real color pixels or pentile pixels. In the pentile pixel, two sub-pixels of different colors are driven as one pixel 101 using a predetermined pixel rendering algorithm to realize a resolution higher than a resolution of the real-color pixel. The pixel rendering algorithm may compensate for insufficient color representation of each pixel using colors of light emitted from adjacent pixels.

The display area AA includes a plurality of pixel lines L1 to Ln. Each of the pixel lines L1 to Ln includes one line of pixels arranged along the line direction (X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln.

The display panel 100 may be implemented with a non-transmissive display panel or a transmissive display panel. The transmissive display panel may be applied to a transparent display device in which an image is displayed on the screen and a real object in the background is visible. The display panel 100 may be made of a flexible display panel.

The power supply 150 receives an input voltage applied from the host system 300 and outputs a voltage needed to drive the pixels 101 of the display panel 100 and the display panel driving circuit. To this end, the power supply 150 may include a direct current to direct current converter (DC-DC converter). The DC-DC converter may include a charge pump, a regulator, a buck converter, a boost converter, and the like. The power supply 150 may output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage may be supplied to the level shifter 140 and the gate driver 120. Voltages such as pixel driving voltage, cathode voltage, and reference voltage may be supplied to the pixels 101 through the power lines commonly connected to the pixels 101.

The display panel driving circuit writes pixel data of the input image to the pixels 101 of the display panel 100 under the control of the timing controller 130. The display panel driving circuit includes a data driver 110 and a gate driver 120.

The display panel driving circuit may further include a touch sensor driver for driving touch sensors. The touch sensor driver is not shown in FIG. 1. The data driver 110 and the touch sensor driver may be integrated into one source drive IC.

The data driver 110 receives pixel data of the input image as a digital signal from the timing controller 130 and outputs a data voltage. The data driver 110 may receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. Additionally, the digital data may include mode selection data for selecting first mode and second mode. The DAC converts the pixel data into a gamma compensation voltage and outputs a data voltage of the pixel data.

The gate driver 120 may be formed on the display panel 100 together with the circuit elements and wiring lines of the display area AA. The gate driver 120 may be disposed in at least one of left and right non-display areas NA outside the display area AA in the display panel 100 or at least a part of the gate driver 120 may be disposed within the display area AA.

The gate driver 120 sequentially outputs pulses of the gate signals to the gate lines 103 under the control of the timing controller 130. The gate driver 120 may sequentially supply the gate signals to the gate lines 103 by shifting the pulses of the gate signals using shift registers. When a plurality of gate signals are applied to each pixel, the gate driver 120 may include a plurality of shift registers. The gate signal may include a scan signal being input to the pixel circuit through a plurality of gate lines, and an emission signal (or EM signal).

The timing controller 130 receives digital video data of an input image and a timing signal synchronized with this data from the host system 300. The timing signal may include a vertical synchronization signal Vsync, a horizontal synchronization signal Hsync, and a data enable signal DE. Since the vertical period and horizontal period may be known by counting the data enable signal DE, the vertical synchronization signal Vsync and the horizontal synchronization signal Hsync may be omitted. The horizontal synchronization signal Hsync and the data enable signal DE have a periodicity of 1 horizontal period (1H).

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 300. The timing controller 130 may synchronize the data driver 110 and the gate driver 120 by controlling the operation timing of the display panel driving circuit.

The gate timing control signal output from the timing controller 130 may be input to the shift register of the gate driver 120 through the level shifter 140. The level shifter 140 may convert a voltage of the gate timing control signal received from the timing controller 130 to a swing width between the gate-on voltage and the gate-off voltage and supply it to the gate driver 120.

The host system 300 may include a main board of one of a television system, a set-top box, a navigation system, a personal computer (PC), a vehicle system, a mobile terminal, and a wearable terminal. The host system 300 may scale an image signal from a video source according to the resolution of the display panel 100, and may transmit it to the timing controller 130 together with the timing signals.

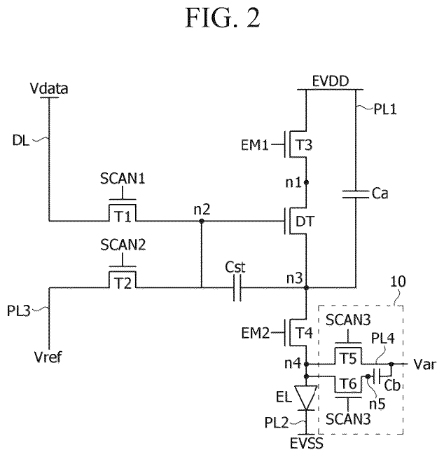

FIG. 2 is a diagram illustrating a pixel circuit according to a first embodiment of the present disclosure.

Referring to FIG. 2, the pixel circuit according to the first embodiment of the present disclosure includes a light-emitting element EL, a driving element DT for supplying a current to the light-emitting element EL, a plurality of switch elements T1 to T4 for switching current paths connected to the driving element DT, a first capacitor Cst, a second capacitor Ca, and a compensation circuit 10. The compensation circuit 10 includes a plurality of switch elements T5 to T6 and a compensation capacitor Cb. The driving element DT and multiple switch elements T1 to T6 may be implemented with, but not limited to, n-channel TFTs.

The light-emitting element EL emits light by a current applied through the channel of the driving element DT in accordance with the gate-source voltage Vgs of the driving element DT that changes according to the data voltage Vdata. The light-emitting element EL may be implemented with an OLED including an organic compound layer formed between the anode and the cathode. The organic compound layer may include, but not limited to, a hole injection layer (HIL), a hole transport layer (HTL), an emission layer (EML), an electron transport layer (ETL), and an electron injection layer (EIL). The anode of the light-emitting element EL is connected to the driving element DT through the third node n3, and the cathode of the light-emitting element EL is connected to a low-potential power voltage line PL2 to which the low-potential power voltage EVSS is applied.

The OLED used as a light-emitting element EL may have a tandem structure in which multiple emission layers are stacked. OLEDs with a tandem structure may improve the luminance and lifetime of pixels.

The driving element DT supplies a current to the light-emitting element EL according to the gate-source voltage Vgs to drive the light-emitting element EL. The driving element DT includes a gate electrode connected to the second node n2, a first electrode (or, drain electrode) connected to the first node n1, and a second electrode (or, source electrode) connected to the third node n3.

The first switch element T1 is turned on according to the gate-on voltage VGH of the first scan signal SCAN1 and connects the data line DL to the second node n2 to apply the data voltage Vdata. The first switch element T1 includes a gate electrode to which the first scan signal SCAN1 is applied, a first electrode connected to the data line DL, and a second electrode connected to the second node n2.

The second switch element T2 is turned on according to the gate-on voltage VGH of the second scan signal SCAN2 and connects the reference voltage line or the third power line PL3 to the second node n2 to apply the reference voltage Vref. The second switch element T2 includes a gate electrode to which the second scan signal SCAN2 is applied, a first electrode connected to the third power line PL3, and a second electrode connected to the second node n2.

The third switch element T3 is turned on according to the gate-on voltage VGH of the first emission signal EM1 and supplies the pixel driving voltage EVDD to the driving element DT. The third switch element T3 includes a gate electrode to which the first emission signal EM1 is applied, a first electrode connected to the pixel driving voltage line to which the pixel driving voltage is applied or to the first power line PL1, and a second electrode connected to the first node n1.

The fourth switch element T4 is turned on according to the gate-on voltage VGH of the second emission signal EM2 and connects the fourth node n4 to the third node n3. The fourth switch element T4 includes a gate electrode to which the second emission signal EM2 is applied, a first electrode connected to the third node n3, and a second electrode connected to the fourth node n4.

The fifth switch element T5 is turned on according to the gate-on voltage VGH of the third scan signal SCAN3 and connects the initialization voltage line or the fourth power line PL4 to the fourth node n4 to apply the initialization voltage Var. The fifth switch element T5 includes a gate electrode to which the third scan signal SCAN3 is applied, a first electrode connected to the fourth node n4, and a second electrode connected to the fourth power line PL4.

The sixth switch element T6 is turned on according to the gate-on voltage VGH of the third scan signal SCAN3 and connects the fourth node n4 to the fifth node n5. The sixth switch element T6 includes a gate electrode to which the third scan signal SCAN3 is applied, a first electrode connected to the fourth node n4, and a second electrode connected to the fifth node n5.

The first capacitor Cst may be connected between the second node n2 and the third node n3. The first capacitor Cst may charge the gate-source voltage Vgs of the driving element DT.

The second capacitor Ca may be connected between the third node n3 and the first power line PL1. The second capacitor Ca may alleviate the voltage fluctuation of the third node n3 caused by a ripple occurrence. That is, even if a ripple occurs at the third node n3, since both the first capacitor Cst and the second capacitor Ca connected to the third node n3 are typically charged, it takes a long time to charge the corresponding capacity, so that the voltage fluctuation caused by the ripple may be alleviated.

The second capacitor Ca may also increase the transfer ratio of the data voltage. Due to the configuration of the second capacitor Ca, while the gate-source voltage Vgs of the driving element DT changes according to a variation in the data voltage Vdata, the current

$$( {I}_{OLED} = {k [ \frac{{C}_{a}}{{C}_{st} + {C}_{a}} ( Vdata - Vref ) ]}^{2} )$$

(where k is a constant) applied to the light-emitting element EL may change depending on the magnitude or capacity of the second capacitor Ca, so that the transfer ratio of the data voltage may change. That is, as the capacity of the second capacitor Ca increases, the current (IOLED) applied to the light-emitting element EL increases, so the transfer ratio of the data voltage may increase.

The compensation capacitor Cb may be connected between the second electrode of the sixth switch element T6 and the fourth power line PL4. The compensation capacitor Cb may compensate for the ripple in the initialization voltage Var, which occurs when the initialization voltage Var is applied, through capacitance coupling.

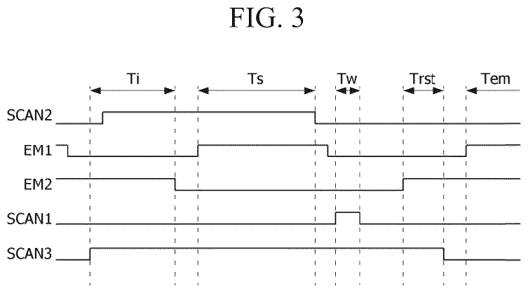

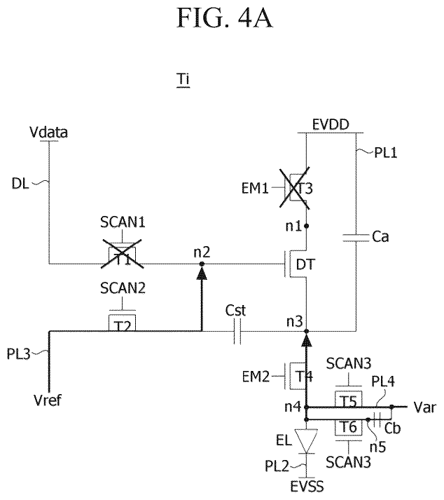

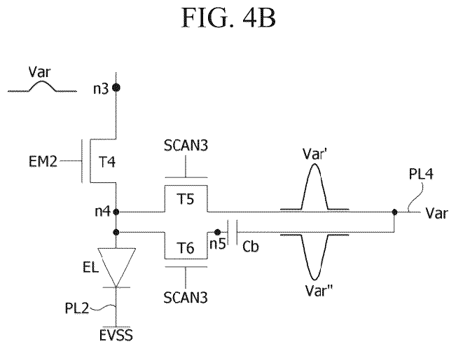

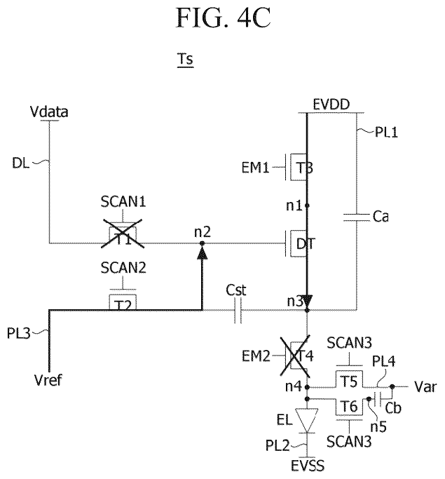

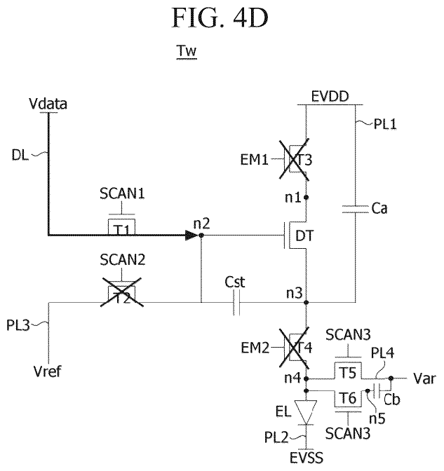

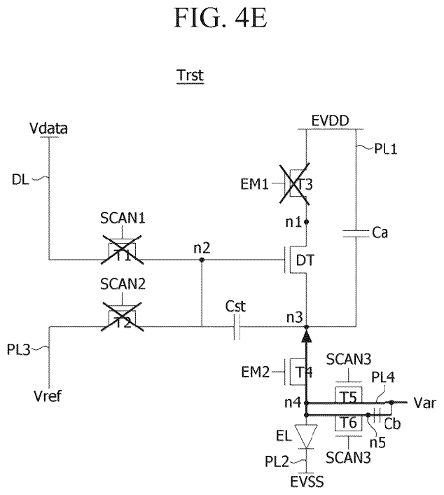

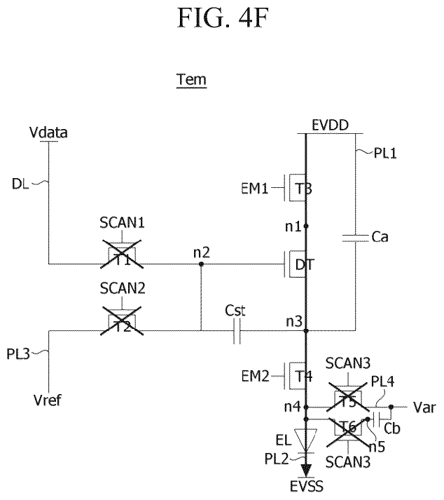

FIG. 3 is a diagram illustrating the driving timing of the pixel circuit shown in FIG. 2, and FIGS. 4A to 4F are diagrams for explaining the operating principle of the pixel circuit according to FIG. 2.

Referring to FIG. 3, the pixel circuit according to an embodiment of the present disclosure may be driven in the order of initialization stage Ti, sensing stage Ts, data writing stage Tw, reset stage Trst, and emission stage Tem.

Referring to FIG. 3 and FIG. 4A, in initialization stage Ti, the first switch element T1 and the third switch element T3 are turned off, and the second switch element T2 and the fourth to sixth switch elements T4 to T6 are turned on, so that the reference voltage Vref is applied to the second node n2, which becomes initialized, and the initialization voltage Var is applied to the third node n3, which becomes initialized. Consequently, the voltage of the second node n2 becomes Vref, and the voltage of the third node n3 becomes Var.

Here, the voltages at the second node n2 and the third node n3 are as shown in Table 1 below.

TABLE 1

| Node | n2 | n3 | Vgs |
|---|---|---|---|
| Voltage | Vref | Var | Vref − Var |

As shown in FIG. 4B, the initialization voltage Var is applied to the third node n3 through the fourth to sixth switch elements T4 to T6. In this case, if the voltage of the third node n3 is −1.5 V and the applied initialization voltage Var is −3.5 V, since the voltage of the third node n3 is higher than the initialization voltage Var, a current flows from the third node n3 to the fourth power line PL4, and this current causes a ripple of first phase in which the initialization voltage Var momentarily rises.

At this time, a current does not flow through the path of the compensation capacitor Cb, but the voltage of the third node n3 is discharged and lowered from −1.5 V to −3.5 V, and this causes a ripple of second phase in which the initialization voltage Var momentarily drops due to the capacitor coupling of the compensation capacitor Cb. Here, the second phase may be the reverse phase of the first phase. Here, for the phase with respect to the initialization voltage, the high voltage region is the first phase, and the low voltage region is the second phase.

While the initialization voltage Var′ having a ripple of first phase is applied to the fourth node n4 through the fifth switch element T5, a compensation voltage Var″ having a ripple of second phase is generated through the sixth switch element T6, so that an initialization voltage Var with a compensated or reduced ripple is generated through combination of the initialization voltage Var′ having a ripple of first phase and the compensation voltage Var″ having a ripple of second phase at the fourth node n4, and the initialization voltage Var whose ripple is compensated for is applied to the third node n3 through the fourth switch element T4.

Referring to FIG. 3 and FIG. 4C, in sensing stage Ts, the first switch element T1 and the fourth switch element T4 are turned off and the second switch element T2 is turned on, so that the reference voltage Vref is applied to the second node n2, the third switch element T3 is turned on, so that the threshold voltage Vth of the driving element DT is sensed and stored in the first capacitor Cst; and the fifth to sixth switch elements T5 to T6 are turned on, so that the initialization voltage Var is applied to the fourth node n4. Consequently, the voltage of the second node n2 becomes Vref, and the voltage of the third node n3 becomes Vref−Vth.

Here, the voltages at the second node n2 and the third node n3 are as shown in Table 2 below.

TABLE 2

| Node | n2 | n3 | Vgs |
|---|---|---|---|
| Voltage | Vref | Vref − Vth | Vth |

Referring to FIG. 3 and FIG. 4D, in data writing stage Tw, the second to fourth switch elements T2 to T4 are turned off, and the first switch element T1 and the fifth to sixth switch elements T5 to T6 are turned on, so that the data voltage Vdata of the pixel data is applied to the second node n2. Hence, the voltage of the second node n2 changes from Vref to Vdata.

Here, the voltages at the second node n2 and the third node n3 are as shown in Table 3 below.

TABLE 3

| Node | n2 | n3 | Vgs |
|---|---|---|---|
| Voltage | Vdata | Vref − Vth + [{Vdata − | Vdata − Vref − Vth + |
| | | Vref} * {Cst/(Cst + Ca)}] | [{Vdata − Vref}*{Cst/ |
| | | | (Cst + Ca)}] |

Referring to FIG. 3 and FIG. 4E, in reset stage Trst, the first to third switch elements T1 to T3 are turned off, and the fourth to sixth switch elements T4 to T6 are turned on, so that the initialization voltage Var is applied to the third node n3. Hence, the voltage of the third node n3 becomes Var.

In reset stage Trst as in initialization stage Ti, while the initialization voltage Var′ having a ripple of first phase is applied to the fourth node n4 through the fifth switch element T5, a compensation voltage Var″ having a ripple of second phase is generated through the sixth switch element T6, so that an initialization voltage Var with a compensated or reduced ripple is generated through combination of the initialization voltage Var′ having a ripple of first phase and the compensation voltage Var″ having a ripple of second phase at the fourth node n4, and the initialization voltage Var whose ripple is compensated for is applied to the third node n3 through the fourth switch element T4.

Referring to FIG. 3 and FIG. 4F, in emission stage Tem, the first to second switch elements T1 to T2 and the fifth to sixth switch elements T5 to T6 are turned off, and the third to fourth switch elements T3 to T4 are turned on, so that the voltages of the second node n2 and the third node n3 rise, and then the light-emitting element EL may emit light with a luminance corresponding to the grayscale value of the pixel data.

Here, the voltages at the second node n2 and the third node n3 are as shown in Table 4 below.

TABLE 4

| Node | n2 | n3 | Vgs |
|---|---|---|---|
| Voltage | Vdata + Var − Vref + Vth − | Var | Vdata − Vref + Vth − |
| | [(Vdata − Vref)*{Cst/ | | [(Vdata − Vref)*{Cst/ |
| | (Cst + Ca)}] | | (Cst + Ca)}] |

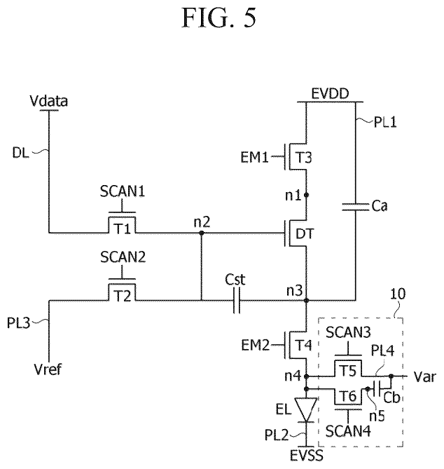

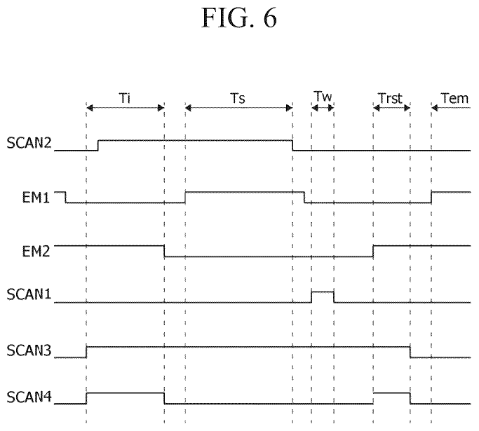

FIG. 5 is a diagram illustrating a pixel circuit according to a second embodiment of the present disclosure, and FIG. 6 is a diagram illustrating the driving timing of the pixel circuit shown in FIG. 5.

Referring to FIG. 5, the pixel circuit according to the second embodiment of the present disclosure includes a light-emitting element EL, a driving element DT that supplies a current to the light-emitting element EL, a plurality of switch elements T1 to T4 that switch current paths connected to the driving element DT, a first capacitor Cst, a second capacitor Ca, and a compensation circuit 10. The compensation circuit 10 includes a plurality of switch elements T5 to T6 and a compensation capacitor Cb.

The pixel circuit of the second embodiment is identical in configuration and operation to the pixel circuit of the first embodiment except for the configuration to apply the initialization voltage, so only the difference will be described.

The fifth switch element T5 is turned on according to the gate-on voltage VGH of the third scan signal SCAN3 and connects the initialization voltage line or the fourth power line PL4 to the fourth node n4 to thereby applying the initialization voltage Var. The fifth switch element T5 includes a gate electrode to which the third scan signal SCAN3 is applied, a first electrode connected to the fourth node n4, and a second electrode connected to the fourth power line PL4.

The sixth switch element T6 is turned on according to the gate-on voltage VGH of the fourth scan signal SCAN4 to thereby connecting the fourth node n4 to the fifth node n5. The sixth switch element T6 includes a gate electrode to which the fourth scan signal SCAN4 is applied, a first electrode connected to the fourth node n4, and a second electrode connected to the fifth node n5.

The compensation capacitor Cb may be connected between the second electrode of the sixth switch element T6 and the fourth power line PL4. The compensation capacitor Cb may compensate for the ripple in the initialization voltage Var, which occurs when the initialization voltage Var is applied, through capacitance coupling.

Referring to FIG. 6, the pixel circuit according to the second embodiment of the present disclosure may be driven in the order of initialization stage Ti, sensing stage Ts, data writing stage Tw, reset stage Trst, and emission stage Tem.

In initialization stage Ti, the first switch element T1 and the third switch element T3 are turned off, and the second switch element T2 and the fourth to sixth switch elements T4 to T6 are turned on, so that the reference voltage Vref is applied to the second node n2, which becomes initialized, and the initialization voltage Var is applied to the third node n3, which becomes initialized. Hence, the voltage of the second node n2 becomes Vref, and the voltage of the third node n3 becomes Var.

Here, as in the first embodiment, while the initialization voltage Var′ having a ripple of first phase is applied to the fourth node n4 through the fifth switch element T5, a compensation voltage Var″ having a ripple of second phase is generated through the sixth switch element T6, so that an initialization voltage Var with a compensated or reduced ripple is generated through combination of the initialization voltage Var′ having a ripple of first phase and the compensation voltage Var″ having a ripple of second phase at the fourth node n4, and the initialization voltage Var whose ripple is compensated for is applied to the third node n3 through the fourth switch element T4.

In sensing stage Ts after initialization stage Ti, the first switch element T1, the fourth switch element T4, and the sixth switch element T6 are turned off, and the second switch element T2 is turned on, so that the reference voltage Vref is applied to the second node n2; the third switch element T3 is turned on, so that the threshold voltage Vth of the driving element DT is sensed and stored in the first capacitor Cst; and the fifth switch element T5 is turned on, so that the initialization voltage Var is applied to the fourth node n4. Hence, the voltage of the second node n2 becomes Vref, and the voltage of the third node n3 becomes Vref−Vth.

In data writing stage Tw after sensing stage Ts, the second to fourth switch elements T2 to T4 and the sixth switch element T6 are turned off, and the first switch element T1 is turned on, so that the data voltage Vdata of the pixel data is applied to the second node n2; and the fifth switch element T5 is turned on, so that the initialization voltage Var is applied to the fourth node n4. Hence, the voltage of the second node n2 changes from Vref to Vdata.

In reset stage Trst after data writing stage Tw, the first to third switch elements T1 to T3 are turned off, and the fourth to sixth switch elements T4 to T6 are turned on, so that the initialization voltage Var is applied to the third node n3. Hence, the voltage of the third node n3 becomes Var.

Here, as in the first embodiment, while the initialization voltage Var′ having a ripple of first phase is applied to the fourth node n4 through the fifth switch element T5, a compensation voltage Var″ having a ripple of second phase is generated through the sixth switch element T6, so that an initialization voltage Var with a compensated or reduced ripple is generated through combination of the initialization voltage Var′ having a ripple of first phase and the compensation voltage Var″ having a ripple of second phase at the fourth node n4, and the initialization voltage Var whose ripple is compensated for is applied to the third node n3 through the fourth switch element T4.

In emission stage Tem after reset stage Trst, the first to second switch elements T1 to T2 and the fifth to sixth switch elements T5 to T6 are turned off, and the third to fourth switch elements T3 to T4 are turned on, so that the voltages of the second node n2 and the third node n3 rise, and then the light-emitting element EL may emit light with a luminance corresponding to the grayscale value of the pixel data.

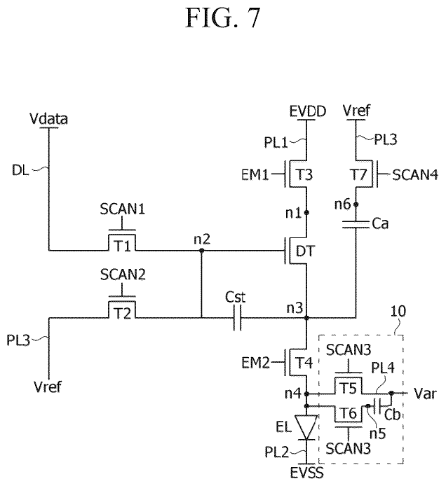

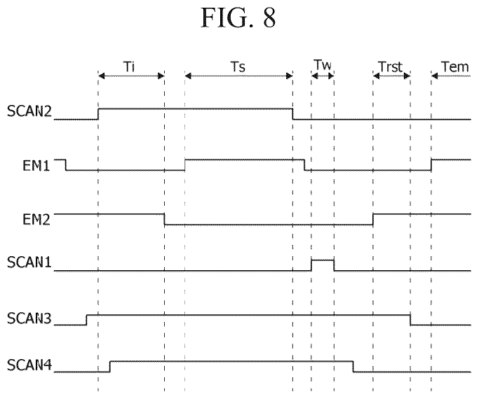

FIG. 7 is a diagram illustrating a pixel circuit according to a third embodiment of the present disclosure, and FIG. 8 is a diagram illustrating the driving timing of the pixel circuit shown in FIG. 7.

Referring to FIG. 7, the pixel circuit according to the third embodiment of the present disclosure includes a light-emitting element EL, a driving element DT that supplies a current to the light-emitting element EL, a plurality of switch elements T1 to T5 that switch current paths connected to the driving element DT, a first capacitor Cst, a second capacitor Ca, and a compensation circuit 10. The compensation circuit 10 includes a plurality of switch elements T6 to T7 and a compensation capacitor Cb. The driving element DT and multiple switch elements T1 to T7 may be implemented with, but not limited to, n-channel TFTs.

The pixel circuit of the third embodiment is identical in configuration and operation to the pixel circuit of the first embodiment except for the configuration of adding a seventh switch element, so only the difference will be described.

The seventh switch element T7 is turned on according to the gate-on voltage VGH of the fourth scan signal SCAN4 and connects the initialization voltage line or fourth power line PL4 to the sixth node n6 to apply the initialization voltage Var. The seventh switch element T7 includes a gate electrode to which the fourth scan signal SCAN4 is applied, a first electrode connected to the third power line PL3, and a second electrode connected to the sixth node n6.

The compensation capacitor Cb may be connected between the second electrode of the sixth switch element T6 and the fourth power line PL4. The compensation capacitor Cb may compensate for the ripple in the initialization voltage Var, which occurs when the initialization voltage Var is applied, through capacitance coupling.

Referring to FIG. 8, the pixel circuit according to the third embodiment of the present disclosure may be driven in the order of initialization stage Ti, sensing stage Ts, data writing stage Tw, reset stage Trst, and emission stage Tem.

In initialization stage Ti, the first switch element T1 and the third switch element T3 are turned off, and the second switch element T2 is turned on, so that the reference voltage Vref is applied to the second node n2, which becomes initialized; and the fourth to seventh switch elements T4 to T7 are turned on, so that the initialization voltage Var is applied to the third node n3, which becomes initialized. Hence, the voltage of the second node n2 becomes Vref, and the voltage of the third node n3 becomes Var.

Here, as in the first embodiment, while the initialization voltage Var′ having a ripple of first phase is applied to the fourth node n4 through the fifth switch element T5, a compensation voltage Var″ having a ripple of second phase is generated through the sixth switch element T6, so that an initialization voltage Var with a compensated or reduced ripple is generated through combination of the initialization voltage Var′ having a ripple of first phase and the compensation voltage Var″ having a ripple of second phase at the fourth node n4, and the initialization voltage Var whose ripple is compensated for is applied to the third node n3 through the fourth switch element T4.

In sensing stage Ts after initialization stage Ti, the first switch element T1 and the fourth switch element T4 are turned off, and the second switch element T2 is turned on, so that the reference voltage Vref is applied to the second node n2; the third switch element T3 is turned on, so that the threshold voltage Vth of the driving element DT is sensed and stored in the first capacitor Cst; the fifth to sixth switch elements T5 to T6 are turned on, so that the initialization voltage Var is applied to the fourth node n4; and the seventh switch element T7 is turned on, so that the reference voltage Vref is applied to the sixth node n6. Hence, the voltage of the third node n3 becomes Vref−Vth.

Here, as in initialization stage Ti, the initialization voltage Var with a compensated or reduced ripple is applied to the fourth node n4 through combination of the initialization voltage Var′ having a ripple of first phase via the fifth switch element T5 and the compensation voltage Var″ having a ripple of second phase via the sixth switch element T6.

In data writing stage Tw after sensing stage Ts, the second to fourth switch elements T2 to T4 are turned off, and the first switch element T1 is turned on, so that the data voltage Vdata of the pixel data is applied to the second node n2; the fifth to sixth switch elements T5 to T6 are turned on, so that the initialization voltage Var is applied to the fourth node n4; and the seventh switch element T7 is turned on, so that the reference voltage Vref is applied to the sixth node n6. Hence, the voltage of the second node n2 changes from Vref to Vdata.

Here, as in initialization stage Ti, the initialization voltage Var with a compensated or reduced ripple is applied to the fourth node n4 through combination of the initialization voltage Var′ having a ripple of first phase via the fifth switch element T5 and the compensation voltage Var″ having a ripple of second phase via the sixth switch element T6.

In reset stage Trst after data writing stage Tw, the first to third switch elements T1 to T3 and the seventh switch element T7 are turned off, and the fourth to sixth switch elements T4 to T6 are turned on, so that the initialization voltage Var is applied to the third node n3. Hence, the voltage of the third node n3 becomes Var.

Here, as in the first embodiment, while the initialization voltage Var′ having a ripple of first phase is applied to the fourth node n4 through the fifth switch element T5, a compensation voltage Var″ having a ripple of second phase is generated through the sixth switch element T6, so that an initialization voltage Var with a compensated or reduced ripple is generated through combination of the initialization voltage Var′ having a ripple of first phase and the compensation voltage Var″ having a ripple of second phase at the fourth node n4, and the initialization voltage Var whose ripple is compensated for is applied to the third node n3 through the fourth switch element T4.

In emission stage Tem after reset stage Trst, the first to second switch elements T1 to T2 and the fifth to seventh switch elements T5 to T7 are turned off, and the third to fourth switch elements T3 to T4 are turned on, so that the voltages of the second node n2 and the third node n3 rise, and then the light-emitting element EL may emit light with a luminance corresponding to the grayscale value of the pixel data.

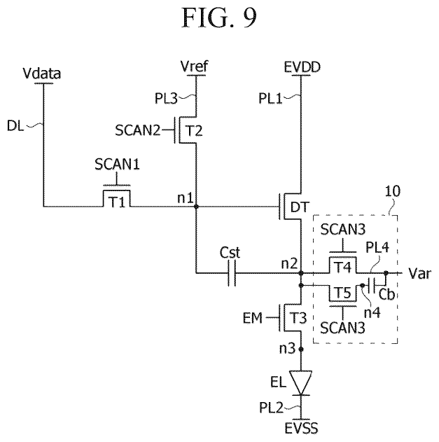

FIG. 9 is a diagram illustrating a pixel circuit according to a fourth embodiment of the present disclosure.

Referring to FIG. 9, the pixel circuit according to the fourth embodiment of the present disclosure includes a light-emitting element EL, a driving element DT that supplies a current to the light-emitting element EL, a plurality of switch elements T1 to T3 that switch current paths connected to the driving element DT, a capacitor Cst, and a compensation circuit 10. The compensation circuit 10 includes a plurality of switch elements T4 to T5 and a compensation capacitor Cb. The driving element DT and multiple switch elements T1 to T5 may be implemented with, but not limited to, n-channel TFTs.

The light-emitting element EL emits light by a current applied through the channel of the driving element DT in accordance with the gate-source voltage Vgs of the driving element DT that changes according to the data voltage Vdata.

The driving element DT supplies a current to the light-emitting element EL according to the gate-source voltage Vgs to drive the light-emitting element EL. The driving element DT includes a gate electrode connected to the first node n1, a first electrode (or, drain electrode) connected to the pixel driving voltage line to which the pixel driving voltage is applied or the first power line PL1, and a second electrode (or, source electrode) connected to the second node n2.

The first switch element T1 is turned on according to the gate-on voltage VGH of the first scan signal SCAN1 to thereby connecting the data line DL to the first node n1 to apply the data voltage Vdata. The first switch element T1 includes a gate electrode to which the first scan signal SCAN1 is applied, a first electrode connected to the data line DL, and a second electrode connected to the first node n1.

The second switch element T2 is turned on according to the gate-on voltage VGH of the second scan signal SCAN2 to thereby connecting the reference voltage line or third power line PL3 to the first node n1 to apply the reference voltage Vref. The second switch element T2 includes a gate electrode to which the second scan signal SCAN2 is applied, a first electrode connected to the third power line PL3, and a second electrode connected to the first node n1.

The third switch element T3 is turned on according to the gate-on voltage VGH of the emission signal EM to thereby connecting the third node n3 to the second node n2. The third switch element T3 includes a gate electrode to which the emission signal EM is applied, a first electrode connected to the second node n2, and a second electrode connected to the third node n3.

The fourth switch element T4 is turned on according to the gate-on voltage VGH of the third scan signal SCAN3 to thereby connecting the initialization voltage line or fourth power line PL4 to the second node n2 to apply the initialization voltage Var. The fourth switch element T4 includes a gate electrode to which the third scan signal SCAN3 is applied, a first electrode connected to the second node n2, and a second electrode connected to the fourth power line PL4.

The fifth switch element T5 is turned on according to the gate-on voltage VGH of the third scan signal SCAN3 to thereby connecting the fourth node n4 to the second node n2. The fifth switch element T5 includes a gate electrode to which the third scan signal SCAN3 is applied, a first electrode connected to the second node n2, and a second electrode connected to the fourth node n4.

The capacitor Cst may be connected between the first node n1 and the second node n2. The capacitor Cst may charge the gate-source voltage Vgs of the driving element DT.

The compensation capacitor Cb may be connected between the second electrode of the fifth switch element T5 and the fourth power line PL4. The compensation capacitor Cb may compensate for the ripple in the initialization voltage Var, which occurs when the initialization voltage Var is applied, through capacitance coupling.

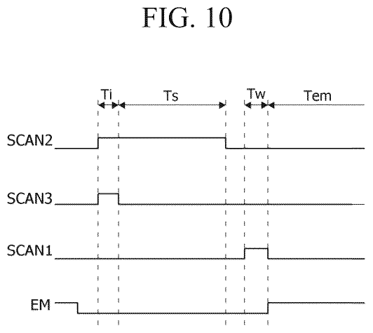

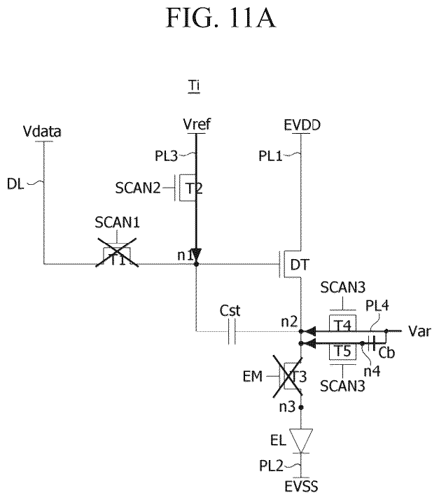

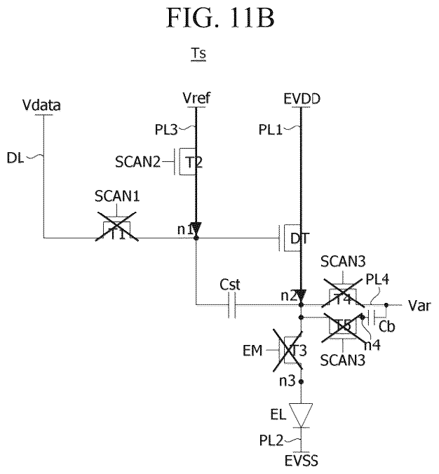

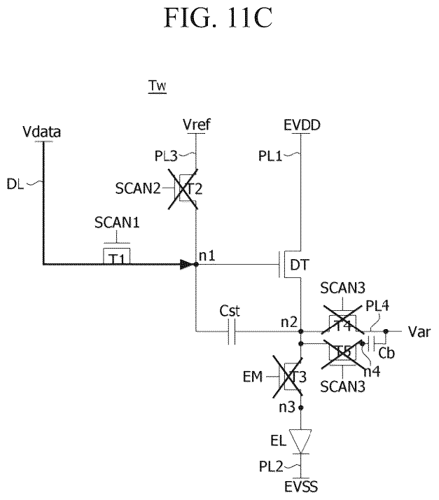

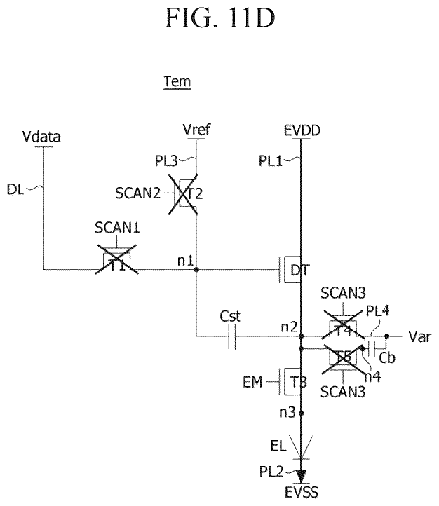

FIG. 10 is a diagram illustrating the driving timing of the pixel circuit shown in FIG. 9, and FIGS. 11A to 11D are diagrams for explaining the operating principle of the pixel circuit according to FIG. 9.

Referring to FIG. 10, the pixel circuit according to the third embodiment of the present disclosure may be driven in the order of initialization stage Ti, sensing stage Ts, data writing stage Tw, and emission stage Tem.

Referring to FIG. 10 and FIG. 11A, in initialization stage Ti, the first switch element T1 and the third switch element T3 are turned off, and the second switch element T2 is turned on, so that the reference voltage Vref is applied to the first node n1, which becomes initialized; and the fourth to fifth switch elements T4 to T5 are turned on, so that the initialization voltage Var is applied to the second node n2, which becomes initialized. Hence, the voltage of the first node n1 becomes Vref, and the voltage of the second node n2 becomes Var.

Here, as in the first embodiment, while the initialization voltage Var′ having a ripple of first phase is applied to the second node n2 through the fourth switch element T4, a compensation voltage Var″ having a ripple of second phase is generated through the fifth switch element T5, so that an initialization voltage Var with a compensated or reduced ripple is generated and applied through combination of the initialization voltage Var′ having a ripple of first phase and the compensation voltage Var″ having a ripple of second phase at the second node n2.

Referring to FIG. 10 and FIG. 11i, in sensing stage Ts, the first switch element T1 and the third to fifth switch elements T3 to T5 are turned off, and the second switch element T2 is turned on, so that the threshold voltage Vth of the driving element DT is sensed and stored in the capacitor Cst. Hence, the voltage of the first node n1 becomes Vref, and the voltage of the second node n2 becomes Vref−Vth.

Referring to FIG. 10 and FIG. 11C, in data writing stage Tw, the second to fifth switch elements T2 to T5 are turned off, and the first switch element T1 is turned on, so that the data voltage Vdata of the pixel data is applied to the first node n1. Hence, the voltage of the first node n1 changes from Vref to Vdata.

Referring to FIG. 10 and FIG. 11D, in emission stage Tem, the first to second switch elements T1 to T2 and the fourth to fifth switch elements T4 to T5 are turned off, and the third switch element T3 is turned on, so that the voltages of the first node n1 and the second node n2 rise, and then the light-emitting element EL may emit light with a luminance corresponding to the grayscale value of the pixel data.

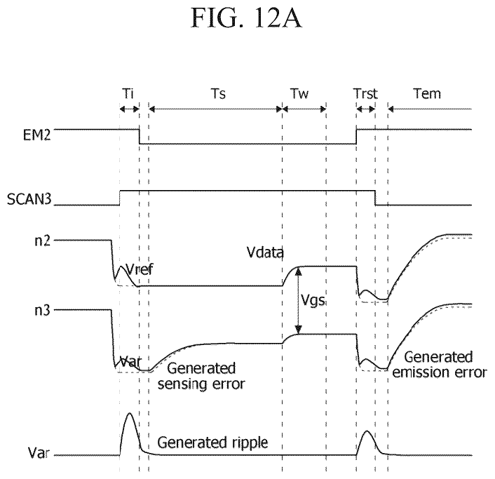

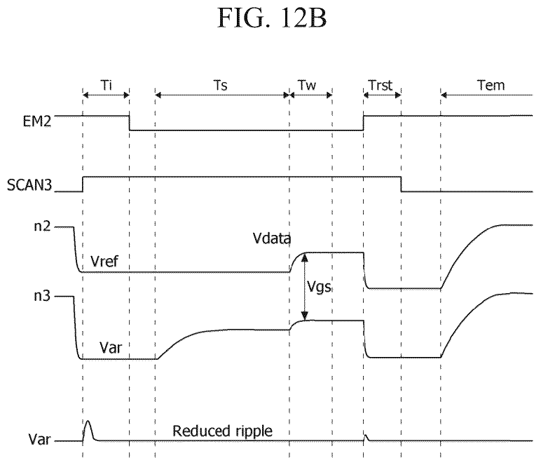

FIGS. 12A and 12B are diagrams illustrating a ripple reduction effect obtained by the pixel circuit.

Referring to FIG. 12A and FIG. 12B, the ripple reduction by the pixel circuit of the embodiment is illustrated. In the comparative example of FIG. 12A, since the sixth switch element T6 and the compensation capacitor Cb in FIG. 2 are absent, a ripple occurs in the initialization voltage supplied only through the fifth switch element T5 to the fourth node n4, which causes the voltages at the second node n2 and the third node n3 to fluctuate.

Since the voltage at the second node n2 and the third node n3 rises, it may cause a sensing error in which a non-normal threshold voltage is sensed and an emission error in which the emission time becomes earlier. Here, the emission error may cause a problem in which the luminance increases especially at a low grayscale level.

On the other hand, in the embodiment of FIG. 12B, it may be seen that while an initialization voltage having a ripple of first phase is supplied to the fourth node n4 in FIG. 2 through the fifth switch element T5, a compensation voltage having a ripple of second phase being the reverse phase of the first phase is supplied together through the compensation capacitor Cb and the sixth switch element T6, thereby generating an initialization voltage with a reduced ripple, and as a result, the voltages at the second node n2 and the third node n3 are stably maintained.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A pixel circuit comprising:
a light-emitting element;
a driving element that drives the light-emitting element and includes a first electrode connected to a first node, a gate electrode connected to a second node, and a second electrode connected to a third node;
a first switch element that supplies a data voltage to the second node in response to a first scan signal;
a second switch element that supplies a reference voltage to the second node in response to a second scan signal;
a third switch element that supplies a pixel driving voltage to the first node in response to a first emission signal;
a fourth switch element that connects a fourth node to the third node in response to a second emission signal;
a compensation circuit that supplies an initialization voltage to the fourth node in response to a third scan signal and supplies a compensation voltage for compensating for a ripple in the initialization voltage to the fourth node; and
a first capacitor connected between the second node and the third node.

2. The pixel circuit of claim 1, wherein the compensation circuit comprises:
a fifth switch element that supplies an initialization voltage having a ripple of first phase to the fourth node in response to the third scan signal;
a sixth switch element that supplies a compensation voltage having a ripple of second phase being a reverse phase of the first phase to the fourth node in response to the third scan signal; and
a compensation capacitor connected to a second electrode of the sixth switch element.

3. The pixel circuit of claim 2, further comprising:
a second capacitor connected between a line to which the pixel driving voltage is applied and the third node.

4. The pixel circuit of claim 2, further comprising:
a second capacitor connected to the third node; and
a seventh switch element connected between the second capacitor and a line to which the reference voltage is applied.

5. The pixel circuit of claim 1, wherein the compensation circuit comprises:
a fifth switch element that supplies an initialization voltage having a ripple of first phase to the fourth node in response to the third scan signal;
a sixth switch element that supplies a compensation voltage having a ripple of second phase being a reverse phase of the first phase to the fourth node in response to a fourth scan signal; and
a compensation capacitor connected to a second electrode of the sixth switch element.

6. The pixel circuit of claim 2 or 4, wherein:
the pixel circuit is driven in order of initialization stage, sensing stage, data writing stage, reset stage, and emission stage; and
in the initialization stage and the reset stage, the fourth switch element, the fifth switch element, and the sixth switch element are turned on.

7. The pixel circuit of claim 6, wherein:
the first switch element includes a first electrode connected to a line to which the data voltage is applied, a gate electrode to which the first scan signal is applied, and a second electrode connected to the second node;
the second switch element includes a first electrode connected to a line to which the reference voltage is applied, a gate electrode to which the second scan signal is applied, and a second electrode connected to the second node;
the third switch element includes a first electrode connected to a line to which the pixel driving voltage is applied, a gate electrode to which the first emission signal is applied, and a second electrode connected to the first node; and
the fourth switch element includes a first electrode connected to the third node, a gate electrode to which the second emission signal is applied, and a second electrode connected to the fourth node.

8. The pixel circuit of claim 7, wherein:
the fifth switch element includes a first electrode connected to the fourth node, a gate electrode to which the third scan signal is applied, and a second electrode connected to a line to which the initialization voltage is applied; and
the sixth switch element includes a first electrode connected to the fourth node, a gate electrode to which the third scan signal or a fourth scan signal is applied, and a second electrode connected to the compensation capacitor.

9. A pixel circuit comprising:
a light-emitting element;
a driving element that drives the light-emitting element and includes a first electrode connected to a line to which a pixel driving voltage is applied, a gate electrode connected to a first node, and a second electrode connected to a second node;
a first switch element that supplies a data voltage to the first node in response to a first scan signal;
a second switch element that supplies a reference voltage to the first node in response to a second scan signal;
a third switch element that connects an anode electrode of the light-emitting element to the second node in response to an emission signal;
a compensation circuit that supplies an initialization voltage to a fourth node in response to a third scan signal and supplies a compensation voltage for compensating for a ripple in the initialization voltage to the second node; and
a first capacitor connected between the first node and the second node.

10. The pixel circuit of claim 9, wherein the compensation circuit comprises:
a fifth switch element that supplies an initialization voltage having a ripple of first phase to the second node in response to the third scan signal;
a sixth switch element that supplies a compensation voltage having a ripple of second phase being a reverse phase of the first phase to the second node in response to the third scan signal; and
a compensation capacitor connected to a second electrode of the sixth switch element.

11. A display device comprising:
a display panel on which a plurality of data lines, a plurality of gate lines intersecting the plurality of data lines, and a plurality of pixel circuits are arranged,
wherein each of the pixel circuits comprises:
a light-emitting element;
a driving element that drives the light-emitting element and includes a first electrode connected to a first node, a gate electrode connected to a second node, and a second electrode connected to a third node;
a first switch element that supplies a data voltage to the second node in response to a first scan signal;
a second switch element that supplies a reference voltage to the second node in response to a second scan signal;
a third switch element that supplies a pixel driving voltage to the first node in response to a first emission signal;
a fourth switch element that connects a fourth node to the third node in response to a second emission signal;
a compensation circuit that supplies an initialization voltage to the fourth node in response to a third scan signal and supplies a compensation voltage for compensating for a ripple in the initialization voltage to the fourth node; and
a first capacitor connected between the second node and the third node.

12. The display device of claim 11, wherein the compensation circuit comprises:
a fifth switch element that supplies an initialization voltage having a ripple of first phase to the fourth node in response to the third scan signal;
a sixth switch element that supplies a compensation voltage having a ripple of second phase being a reverse phase of the first phase to the fourth node in response to the third scan signal; and
a compensation capacitor connected to a second electrode of the sixth switch element.

13. The display device of claim 12, further comprising:
a second capacitor connected between a line to which the pixel driving voltage is applied and the third node.

14. The display device of claim 12, further comprising:
a second capacitor connected to the third node; and
a seventh switch element connected between the second capacitor and a line to which the reference voltage is applied.

15. The display device of claim 11, wherein the compensation circuit comprises:
a fifth switch element that supplies an initialization voltage having a ripple of first phase to the fourth node in response to the third scan signal;
a sixth switch element that supplies a compensation voltage having a ripple of second phase being a reverse phase of the first phase to the fourth node in response to a fourth scan signal; and
a compensation capacitor connected to a second electrode of the sixth switch element.

16. The display device of claim 12, wherein:
the pixel circuit is driven in order of initialization stage, sensing stage, data writing stage, reset stage, and emission stage; and
in the initialization stage and the reset stage, the fourth switch element, the fifth switch element, and the sixth switch element are turned on.

17. The display device of claim 16, wherein:
the first switch element includes a first electrode connected to a line to which the data voltage is applied, a gate electrode to which the first scan signal is applied, and a second electrode connected to the second node;
the second switch element includes a first electrode connected to a line to which the reference voltage is applied, a gate electrode to which the second scan signal is applied, and a second electrode connected to the second node;
the third switch element includes a first electrode connected to a line to which the pixel driving voltage is applied, a gate electrode to which the first emission signal is applied, and a second electrode connected to the first node; and
the fourth switch element includes a first electrode connected to the third node, a gate electrode to which the second emission signal is applied, and a second electrode connected to the fourth node.

18. The display device of claim 17, wherein:
the fifth switch element includes a first electrode connected to the fourth node, a gate electrode to which the third scan signal is applied, and a second electrode connected to a line to which the initialization voltage is applied; and
the sixth switch element includes a first electrode connected to the fourth node, a gate electrode to which the third scan signal or a fourth scan signal is applied, and a second electrode connected to the compensation capacitor.

19. A display device comprising:
a display panel on which a plurality of data lines, a plurality of gate lines intersecting the plurality of data lines, and a plurality of pixel circuits are arranged,
wherein each of the pixel circuits comprises:
a light-emitting element;
a driving element that drives the light-emitting element and includes a first electrode connected to a line to which a pixel driving voltage is applied, a gate electrode connected to a first node, and a second electrode connected to a second node;
a first switch element that supplies a data voltage to the first node in response to a first scan signal;
a second switch element that supplies a reference voltage to the first node in response to a second scan signal;
a third switch element that connects an anode electrode of the light-emitting element to the second node in response to an emission signal;
a compensation circuit that supplies an initialization voltage to the second node in response to a third scan signal and supplies a compensation voltage for compensating for a ripple in the initialization voltage to the second node; and
a first capacitor connected between the first node and the second node.

20. The display device of claim 19, wherein the compensation circuit comprises:
a fifth switch element that supplies an initialization voltage having a ripple of first phase to the second node in response to the third scan signal;
a sixth switch element that supplies a compensation voltage having a ripple of second phase being a reverse phase of the first phase to the second node in response to the third scan signal; and
a compensation capacitor connected to a second electrode of the sixth switch element.
